(19) United States
(12) Patent Application Publication
(10) Pub. No.: US 2009/0300242 A1
(43) Pub. Date: Dec. 3, 2009

(54) Audio Data Processor and Method for Processing Audio Data

(75) Inventors: Yoshikazu Shiomi, Hamura-shi (JP); Takanobu Mukaide, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/398,067

(22) Filed: Mar. 4, 2009

(30) Foreign Application Priority Data
May 30, 2008 (JP) 2008-143506

(51) Int. Cl. G06F 13/12; G06F 1/12

(52) U.S. Cl. 710/69; 710/61

(57) ABSTRACT

An audio data processor includes: a digital interface configured to transfer first audio data to an external apparatus through a one-way bus and transfers second audio data being in parallel with the first audio data regarding playback time to the external apparatus through an asynchronous two-way bus; and a controller configured to output a bit stream obtained by adding time information for specifying the playback time successively to the first audio data to the one-way bus, acquire an output request issued for each piece of the time information obtained successively from the bit stream from the external apparatus through the asynchronous two-way bus, and output a part of the second audio data corresponding to the time information of the output request through the asynchronous two-way bus.

### CROSS REFERENCE TO RELATED APPLICATION(S)

The present disclosure relates to the subject matters contained in Japanese Patent Application No. 2008-143506 filed on May 30, 2008, which are incorporated herein by reference in its entirety.

### FIELD

The present invention relates to an audio data processor and a method for processing audio data of main audio and sub audio for external output, for example, in an optical disc player.

### BACKGROUND

Large-capacity optical discs such as DVDs have come into remarkably wide use recently. Most of the existing DVD players are compliant with a digital audio output based on a transfer method such as High-definition Multimedia Interface (HDMI). There is a prospect that DVD players only compliant with the HDMI-based audio output but provided with no analog audio output terminal will appear in the future.

The HDMI has a one-way bus for video and audio data. The one-way bus can transfer audio data as a compressed bit stream at a high speed. In HDMI version 1.3 or later, a transfer format of High-Bit-Rate Audio (HBR Audio) has been defined for bit stream transfer of high-bit-rate audio data such as TrueHD or DTS-HD.

Although a large-capacity optical disc has contents containing various kinds of audio data such as main audio and sub audio, the HDMI is not a specification that bit streams of the various kinds of audio data can be parallel-transferred to an external apparatus such as an AV amplifier. For this reason, when, for example, the one-way bus is occupied by audio data of main audio output as a bit stream, audio data of sub audio cannot be output and must be discarded.

To solve such a problem, there has been heretofore proposed a method in which audio data of main audio is output as digital data from HDMI, etc. whereas audio data of sub audio is converted from digital signal to analog signal and output as analog data from an analog audio output terminal. An example of such method is disclosed in JP-A-2007-213663.

It is however impossible to apply the method described in the publication JP-A-2007-213663 to the case where there is no analog audio output terminal provided.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a view schematically showing an audio playback system according to an embodiment of the invention.

FIG. 2 is a view showing a sequence of operations in a reproducing apparatus and an AV amplifier shown in FIG. 1.

FIG. 3 is a view showing an IEC61937 format used in a main audio output controller shown in FIG. 1 and time information embedded in the format.

### DETAILED DESCRIPTION OF THE EMBODIMENTS

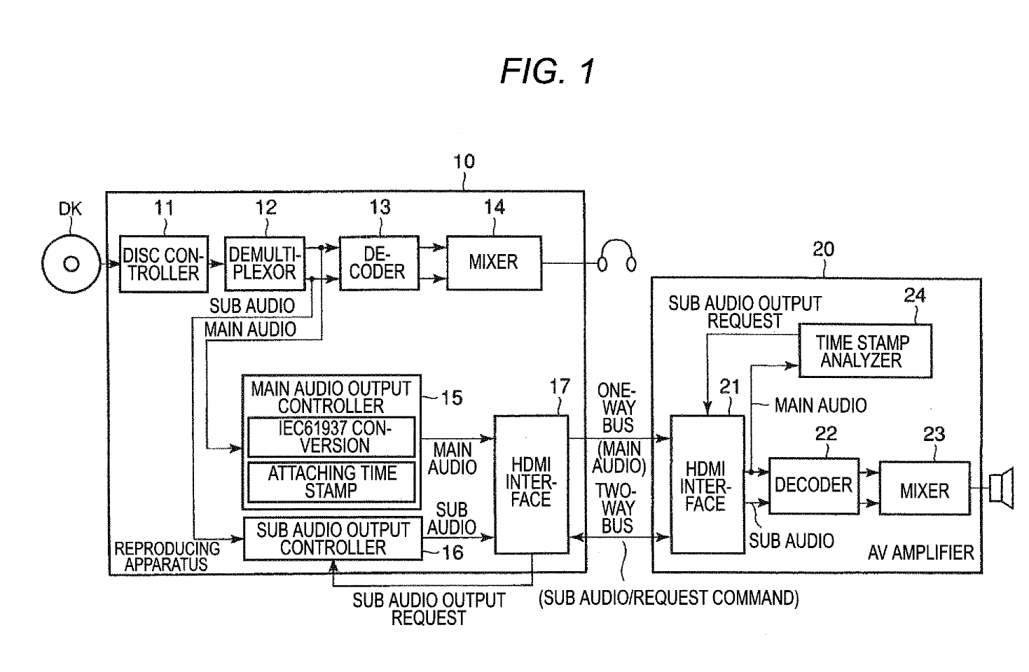

An audio playback system according to an embodiment of the invention will be described below with reference to the accompanying drawings. FIG. 1 schematically shows the configuration of the audio playback system. The audio playback system includes a reproducing apparatus 10, and an AV amplifier 20. The reproducing apparatus 10 reproduces audio data of main audio and audio data of sub audio from a program stream recorded on an optical disc DK, for example, in a large-capacity optical disc player. The AV amplifier 20 is an external apparatus which is externally provided with respect to the reproducing apparatus 10. The reproducing apparatus 10 has a disc controller 11, a demultiplexor 12, a decoder 13, a mixer 14, a main audio output controller 15, a sub audio output controller 16, and an HDMI interface 17. The HDMI interface 17 is a digital interface which transfers audio data of main audio to the AV amplifier 20 through a one-way bus B1 and transfers audio data of sub audio parallel with the audio data of main audio regarding playback time to the AV amplifier 20 through an asynchronous two-way bus B2. The main audio output controller 15 and the sub audio output controller 16 form a controller which performs control so that a bit stream obtained by adding time information as time stamps for specifying playback time successively to audio data of main audio is output to the one-way bus B1, that an output request issued for each piece of the time information obtained successively from the bit stream in the AV amplifier 20 is acquired from the two-way bus B2, and that part of audio data of sub audio corresponding to the time information of the output request is output to the two-way bus B2.

The disc controller 11 reads a program stream from an optical disc DK and feeds the program stream to the demultiplexor 12. The demultiplexor 12 demultiplexes the program stream by packet types such as video and audio. With respect to each audio packet, audio data of main audio and audio data of sub audio are decoded by the decoder 13, mixed by the mixer 14 and output to a headphone terminal.

The audio data of main audio and the audio data of sub audio are further fed from the demultiplexor 12 to the main audio output controller 15 and the sub audio output controller 16 respectively. The main audio output controller 15 is configured to perform a process of converting the audio data of main audio obtained from the program stream into an IEC61937 format having an auxiliary recording space while embedding time information for specifying playback time in the auxiliary recording space. The sub audio output controller 16 is configured to perform a process of selecting part of the audio data of sub audio obtained from the program stream in accordance with the time information of the output request.

The AV amplifier 20 has an HDMI interface 21, a decoder 22, a mixer 23, and a time stamp analyzer 24. The HDMI interface 21 is a digital interface which receives audio data of main audio through the one-way bus B1 and receives audio data of sub audio through the two-way bus B2. The audio data of main audio and the audio data of sub audio obtained from the HDMI interface 21 are decoded by the decoder 22, mixed by the mixer 23 and output to a speaker output terminal. A bit stream obtained by adding time information successively to the audio data of main audio is transferred from the HDMI interface 17 to the HDMI interface 21 through the one-way bus B1. The time stamp analyzer 24 analyzes the bit stream, acquires the time information successively from the bit stream and issues a sub audio request command to request a sub audio output for each piece of the time information. The sub audio request command is transferred from the HDMI interface 21 to the HDMI interface 17 through the two-way bus B2 and fed from the HDMI interface 17 to the sub audio output controller 16.

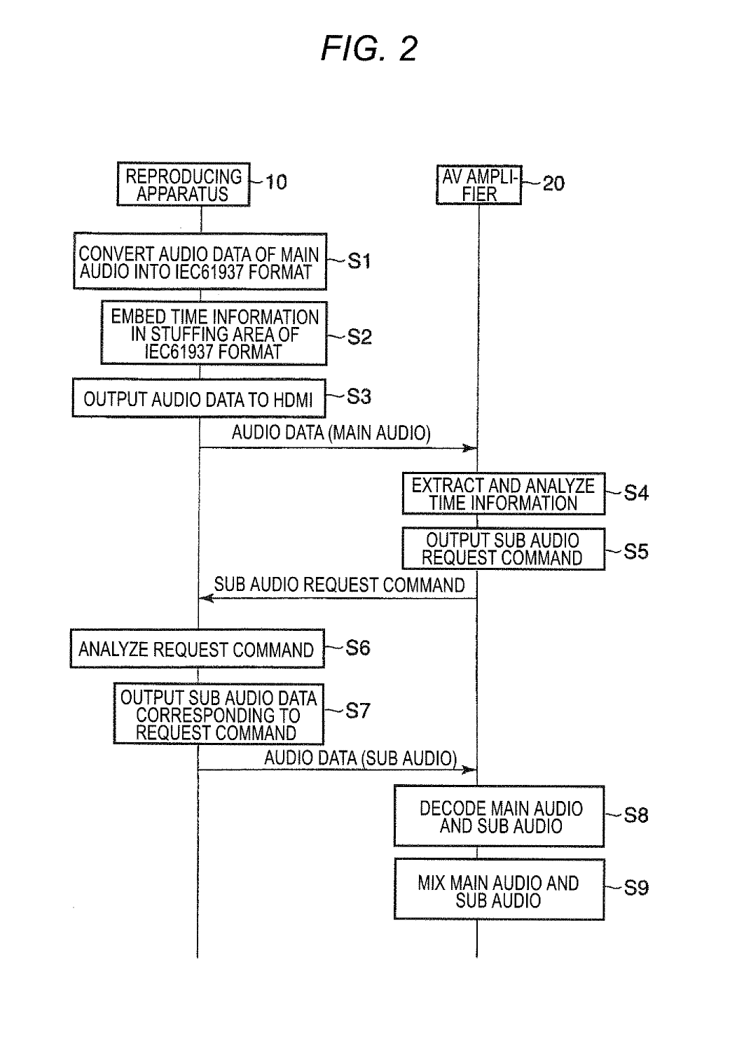

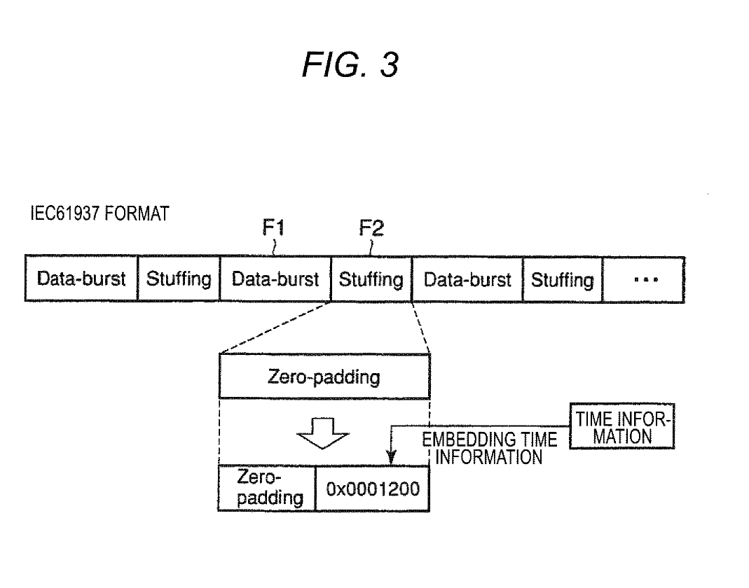

FIG. 2 shows a sequence of operations in the reproducing apparatus 10 and the AV amplifier 20. When audio data is output as a bit stream (compressed audio data) the decoding process in the decoder 13 can be omitted. In the reproducing apparatus 10, when audio data of main audio is converted into an IEC61937 format in step S1, pieces of time information are embedded in stuffing areas of the IEC61937 format. The IEC61937 format is formed as iteration of a frame having a data-burst area F1 and a stuffing area F2 as shown in FIG. 3. The data-burst area is a storage area of audio data. The stuffing area is an area padded with “0” values used for adjusting the interval between adjacent data-burst areas. The Standard has such a definition that the stuffing area has a size of 8 bytes or more. In the main audio output controller 15, part of the area padded with “0” values is used as an auxiliary recording space so that time information is embedded in the auxiliary recording space. Although description has been made on the case where time information is embedded once per frame, the sub audio request command may be provided to perform control so that time information is embedded, for example, once per four frames. When audio data of main audio is fed as a bit stream of the IEC61937 format containing added time information to the HDMI interface 17, the HDMI interface 17 transfers the bit stream of audio data of main audio to the AV amplifier 20 through the one-way bus B1 in step S3.

Upon reception of the bit stream of audio data of main audio, the HDMI interface 21 of the AV amplifier 20 feeds the bit stream both to the decoder 22 and to the time stamp analyzer 24. The time stamp analyzer 24 extracts time information from the stuffing areas of the IEC61937 format in the bit stream and analyzes the time information in step S4. Then, the time stamp analyzer 24 issues a sub audio request command to request a sub audio output. The sub audio request command, which contains time information attached thereto as a time stamp for specifying playback time of audio data of sub audio, is fed to the HDMI interface 21. Although description has been made on the case where the attached time information coincides with the time information extracted from audio data of main audio, the two pieces of time information need not coincide with each other. That is, when the audio data of main audio to be played back simultaneously with the audio data of sub audio requested to be output has been already received, the start of playback of the audio data of main audio need to be delayed until the audio data of sub audio is received. Therefore, if an offset value is added to the time information attached to the sub audio request command, the audio data of sub audio to be played back simultaneously with the audio data of main audio can be received prior to the audio data of main audio so that the aforementioned delay can be dispensed with.

The sub audio request command is fed from the time stamp analyzer 24 to the HDMI interface 21 and output to the two-way bus B2 in step S5. In the reproducing apparatus 10, the HDMI interface 17 receives the sub audio request command and feeds the sub audio request command to the sub audio output controller 16. The sub audio output controller 16 analyzes the sub audio request command in step S6 and selects part of the audio data of sub audio corresponding to playback time specified by the time information of the sub audio request command. The part of the audio data of sub audio is fed from the sub audio output controller 16 to the HDMI interface 17 and then output to the two-way bus B2 in step S7.

Upon reception of the audio data of sub audio, the HDMI interface 21 of the AV amplifier 20 feeds the audio data of sub audio to the decoder 22. The decoder 22 decodes the audio data of main audio received from the one-way bus B1 and the audio data of sub audio received from the two-way bus B2 in step S8 and feeds the decoded audio data to the mixer 23. In step S9, the mixer 23 mixes the audio data of main audio and the audio data of sub audio obtained as decoded results in the decoder 22 and outputs the mixed data to a speaker terminal.

In this embodiment, a bit stream obtained by adding time information for specifying playback time successively to audio data of main audio is output to the one-way bus B1, an output request issued for each piece of the time information obtained successively from the bit stream in the AV amplifier 20 is acquired from the two-way bus B2, and part of audio data of sub audio corresponding to the time information of the output request is output to the two-way bus B2. That is, when the two-way bus B2 is provided in addition to the one-way bus B1, the two-way bus B2 can be used for achieving a digital output of audio data of sub audio. Moreover, in the AV amplifier 20, simultaneity in playback time between audio data of main audio and audio data of sub audio can be achieved by the time information. Accordingly, audio data of sub audio can be output as digital data through the two-way bus B2 without spoiling of simultaneity in playback time with audio data of main audio output as digital data through the one-way bus B1.

In conventional audio compression techniques such as Dolby Digital (trademark registered) and DTS (trademark registered), for digital output (non-HBR Audio output) of audio data of main audio and audio data of sub/effect audio to an external apparatus, these audio data may be decoded by the decoder 13, mixed by the mixer 14 and then re-encoded. The re-encoding can be however dispensed with when the time stamp (time information) attaching method is used as described in this embodiment. Accordingly, a simpler system configuration can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An audio data processing apparatus comprising:
a processor that receives first audio data and second audio data that are to be simultaneously reproduced;
a digital interface that has a one-way bus that transfers the first audio data to an external apparatus and an asynchronous two-way bus that transfers the second audio data to the external apparatus; and
an output controller that operates to:
output through the one-way bus a bit stream obtained by adding time information for specifying playback time successively to the first audio data;
receive through the two-way bus an output request issued for each piece of the time information obtained successively from the bit stream in the external apparatus; and
output through the two-way bus a part of the second audio data corresponding to the time information of the output request.

2. The audio data processing apparatus of claim 1, wherein the processor comprises a demultiplex processor that demultiplexes, from a program stream multiplexed with a video, a main audio and a sub audio, audio data of the main audio and audio data of the sub audio as the first audio data and the second audio data.

3. The audio data processing apparatus of claim 2, wherein the demultiplex processor is connected to a medium controller that reads out the program stream from a recording medium that stores the program stream.

4. The audio data processing apparatus of claim 3, wherein the output controller comprises a main audio output controller that operates to:
receive the audio data of the main audio being demultiplexed from the program stream;
convert the audio data of the main audio into an IEC6197 format that is an audio transferring standard; and
embed the time information into an auxiliary space that is set at a part of Stuffing area in the IEC6197 format.

5. The audio data processing apparatus of claim 3, wherein the output controller comprises a sub audio output controller that operates to:
receive the audio data of sub audio that is demultiplexed from the program stream; and
selects a part corresponding to the time information of the output request from the audio data of the sub audio.

6. An audio data processing method using a digital interface having a one-way bus that transfers the first audio data to an external apparatus and an asynchronous two-way bus that transfers the second audio data to the external apparatus, the method comprising:
outputting through the one-way bus a bit stream obtained by adding time information for specifying playback time successively to the first audio data;
receiving through the two-way bus an output request issued for each piece of the time information obtained successively from the bit stream in the external apparatus; and
outputting through the two-way bus a part of the second audio data corresponding to the time information of the output request.

7. The audio data processing method of claim 6, wherein audio data of a main audio and audio data of a sub audio are demultiplexed as the first audio data and the second audio data from a program stream multiplexed with a video, the main audio and the sub audio.

8. The audio data processing method of claim 7 wherein the program stream is read out from a recording medium that stores the program stream.

9. (canceled)

10. The audio data processing method of claim 8, wherein a part corresponding to the time information of the output request is selected from the audio data of the sub audio that is demultiplexed from the program stream.

11. The audio data processing apparatus of claim 4, wherein the output controller comprises a sub audio output controller that operates to:
receive the audio data of the sub audio that is demultiplexed from the program stream; and
selects a part corresponding to the time information of the output request from the audio data of the sub audio.
